(19) United States
(12) Patent Application Publication
(10) Pub. No.: US 2003/0034873 A1
(43) Pub. Date: Feb. 20, 2003

(54) Systems and methods for controlling vehicle access

(76) Inventors: Robin Chase, Cambridge, MA (US); Antje Danielson, Cambridge, MA (US); Paul Covell, Cambridge, MA (US)

Correspondence Address: LUCASH, GESMER & UPDEGROVE, LLP, 40 BROAD ST, SUITE 300, BOSTON, MA, 02109, US

(21) Appl. No.: 09/785,408

(22) Filed: Feb. 16, 2001

Related U.S. Application Data
(60) Provisional application No. 60/182,766, filed on Feb. 16, 2000.
(60) Provisional application No. 60/243,385, filed on Oct. 26, 2000.

(51) Int. Cl. G06F 7/04

(52) U.S. Cl. 340/5.2; 340/5.54; 340/5.6; 340/5.72; 307/10.3

(57) ABSTRACT

Disclosed are methods and systems for an automated car sharing system. An authorized user makes a reservation to use a vehicle at a certain location, specifying the date and time for the pick-up and drop-off. At the appointed time, the user accesses the vehicle and presents identification to automatically gain access to the car. The system maintains all necessary information such as mileage, length of use, distance, and other such information, and when the user returns the car, automatically generates a bill.

### BACKGROUND OF THE INVENTION

1. Field of the Invention

The present invention relates generally to systems that provide for the shared-use of vehicles. More particularly, the invention relates to a system that allows one of a plurality of drivers to automatically make a reservation for a car, then the system controls the access and use of the car, and the return of the car, including billing.

2. Background of the Invention

The number of cars in cities continues to grow, placing an ever-increasing demand on a limited infrastructure of parking and roads. However, many of these cars are actually in use only a very small fraction of the time. Many drivers commute without a car by walking, bicycling or by public transportation, and their cars sit idle most of the week. Still others may commute by car, though alternative means of transportation are available, primarily because they anticipate a possible need for the car during the workday. These cars simply make traffic worse and needlessly occupy a valuable parking spot most workdays.

Shared-use systems have been described in the prior art, however, current systems are inconvenient for the vehicle drivers. Using a shared vehicle must be as convenient as possible or drivers will choose to use private vehicles instead. The shared vehicles should be located a short walk from a driver's home or work which means that they should be distributed over a wide area rather than centrally located or located in a small number of pods. Transaction time and the number of steps that are required to gain entry to the vehicle should be minimized. Unnecessary steps such as retrieving a key from a kiosk, negotiating a barrier intended to secure the vehicle, filling out forms, etc. should be minimized. In addition, in current systems, the vehicles are frequently not reliably available. A reservation system can enable efficient use of vehicles and helps ensure availability. The reservation system should enable a user to easily select an available vehicle and time, or allow the user to choose from alternatives that are similar to the desired vehicle and time. Access to vehicles should be secure from unauthorized users. During a reservation, access should be restricted to the reserving driver. This provides an expected level of security for the reserving driver and prevents a vehicle from being used without a reservation either maliciously or inadvertently.

Several systems have been described for shared access or shared-use vehicles. Generally these systems describe various methods of access and monitoring vehicles and are not integrated with a reservation system. As such, they provide ways of sharing vehicles that are less economical and/or less reliable than the present invention. Nor are they very scalable, many requiring specialized parking facilities, communication pods, or kiosks.

U.S. Pat. Nos. 3,624,608 and 3,665,397 describe systems that do not restrict access to the vehicles or include any reservation system. These systems require specially-modified stations to effect data transfer to and from the in-vehicle systems at each parking location and specially-modified parking locations for vehicle security. The systems do not provide for a high degree of security or reliability, nor is such a system easily scaled due to the infrastructure required at each parking location.

U.S. Pat. Nos. 5,519,260, 5,660,246 and 5,715,905 describe systems that are primarily concerned with vehicle monitoring and security. These systems do not include a reservation system.

There are a number of systems that require a single parking area, or multiple parking locations, to have a certain amount of infrastructure. Examples of these systems are described in U.S. Pat. Nos. 5,812,070, 5,206,643, 5,726,885 and 5,066,853.

U.S. Pat. No. 5,289,369 discloses a system that does not require any infrastructure modifications to the parking locations, but because the cars are parked in random locations, the system cannot guarantee the availability of a desired vehicle. According to this system, round trips are not required, which can result in an uneven distribution of vehicles, which then need to be redistributed.

It is therefore an object of the present invention to provide a system that allows a number of shared-use vehicles to be used by a number of drivers.

It is also an object to provide a system and method to access and monitor a vehicle-sharing system with an integrated reservation system.

It is a further object of the invention to provide a shared-use vehicle system that is convenient for use by the driver.

It is an additional object to provide a system that makes construction, management, and growth of a shared-use vehicle system economical.

### SUMMARY OF THE INVENTION

These and other objects are attained by the invention, which comprises a method and system for sharing the use of one or more vehicles by a plurality of drivers.

According to the present invention, a system for controlling access to a vehicle is provided. The system includes a vehicle-associated access control module that is located in the vehicle. This module allows access to the vehicle by users who have been authorized by a verification module. The verification module communicates with the vehicle-associated access control module over a communications such as the Internet or a wireless communications system.

The verification module includes a server that stores personal identification information for all authorized users, and vehicle information. The server has a database that stores all reservation requests, including specific vehicles, dates and times, and authorizations.

An authorized user can thus make a reservation for a specific vehicle at a certain date and time, and can request a pick-up and drop-off location. At the appointed time, the user accesses the vehicle and presents identification such as a smart card or PIN to gain access to the car. The system maintains all necessary information such as mileage, length of use, distance, and other such information, and when the user returns the car, automatically generates a bill.

Those skilled in the art will appreciate that the methods, systems and software products described herein can be implemented in systems and software other than the specific examples set forth herein, and such examples are provided by way of illustration rather than limitation.

This specification, including the drawings attached hereto, will next present the invention at various levels of enabling detail, from conceptual to specific examples of implementation.

### BRIEF DESCRIPTION OF THE DRAWINGS

FIG. 1 illustrates one embodiment of the vehicle access control system of the present invention.

FIG. 2 shows an overview of the system.

FIG. 3 shows the system from the point of view of a driver using the system.

FIG. 4 shows Step A of FIG. 3 in more detail.

FIG. 5 shows Step B of FIG. 3 in more detail.

FIG. 6 shows Step C of FIG. 3 in more detail.

FIG. 7 shows Step D of FIG. 3 in more detail.

FIG. 8 illustrates the overall system according to the preferred embodiment.

FIG. 9 shows an alternate embodiment of the system.

FIG. 10 shows the vehicle-associated access control module system in more detail.

### DETAILED DESCRIPTION OF THE INVENTION

The invention is a highly scalable and reliable automated car sharing system based on specially-equipped vehicles and a central resource management reservation system. The central resource management reservation system is highly flexible and facilitates adding and removing vehicles and vehicle locations, and moving vehicles between vehicle locations. An authorized driver can reserve any of the vehicles for an available and desired amount of time, and then enter and use the vehicle in a secure and reliable fashion. Each vehicle is stored in a specific location and after use is returned to a specific location. Vehicles are equipped with means of identifying a driver, means of enabling or refusing use, and means for monitoring, measuring, and reporting use to the central resource management reservation system. The central resource management reservation system also facilitates adding and subtracting drivers to the system and automatically calculating and billing drivers for various fees and vehicle usage charges.

The invention is a system and method of sharing a car, or a fleet of cars, using a resource management reservation system. Each car is outfitted with a vehicle-associated access control module as described below. The main features of the system are the convenient and reliable access to shared vehicles via a reservation system, a means of identifying an authorized driver, a means for allowing or denying entry to, and use of a vehicle, and a means for monitoring vehicle use.

The invention could also be used to enable a specific group of drivers, such as a family, to share access to a single vehicle in a controlled way. The reservation mechanism can easily incorporate a range of rights and privileges for different drivers while guaranteeing or denying access to the vehicle. The invention may also be used to enable a specific group of drivers to share access to several vehicles, such as a corporate fleet of cars or trucks. In this case, the reservation and access mechanism would limit access to the corporate fleet to drivers authorized by the corporation.

Each driver has a unique identifier. The unique identifier may be implemented in the system by a variety of means, including a password or a personal identification number. In the preferred embodiment, a personal identification number assigned to each driver allows secure access to the reservation system of the present invention. The unique identifier may also include a smart card or chip card. In the preferred embodiment, a smart card is used to gain access to a vehicle.

Each of the cars in the fleet is parked in a specific location for a specific amount of time when not in use. A central resource management reservation system stores data and determines when and where each vehicle is parked when not in use, allowing each driver to reliably reserve a specific vehicle for a specific duration.

Each of the cars in the fleet is equipped with a vehicle-associated access control module that has a means of communicating with the central resource management reservation system. The vehicle-associated access control module is also equipped with a means of recognizing the identity of each driver by using a chip card reader, in the preferred embodiment.

Because most wireless communication mechanisms are not available 100% of the time due to poor coverage, environmental shielding effects, or other unforeseen conditions, the vehicle-associated access control module is intended to perform with partial availability of the communications link.

According to the preferred embodiment, a driver wishing to use one of the cars must first make a reservation. The driver may request a specific car in a specific location or one of a pool of cars in a specific location starting and ending at specific times. When the driver makes a reservation, the system checks the status of that particular driver and, if a problem exists with that user's account, notifies the user before continuing with the reservation process. If a requested vehicle or pickup location is not available, the system presents the user with alternate choices for the requested date and time.

If the requested car is available, or if there is adequate availability within the pool of cars, then the reservation is confirmed. Before the start of the reservation, the central resource management reservation system informs the appropriate vehicle-associated access control module of the details of the reservation including the chip card ID of the driver and the start and end time of the reservation.

At the time of the start of the reservation, the driver goes to the specific location and identifies himself by placing the proximity or chip card near the reader. If his ID matches the stored ID, then the vehicle-associated access control module unlocks the car door, disables the vehicle security system, enables ignition, and informs the server. The proximity or chip card is used to lock the car the same way it was used to unlock the car. During the reservation period and beyond, until a different proximity or chip card ID is detected, the vehicle-associated access control module permits the driver's proximity or chip card to be used to unlock and lock the car. At the end of the reservation, the vehicle-associated access control module informs the server of the vehicle usage time and distance traveled. This information permits the server to automatically calculate usage charges and to bill the driver's account accordingly. Because the usage information is tracked automatically, the server can better manage the fleet of vehicles.

The vehicle-associated access control module monitors the status of the wireless communications link to the server. If there is ever a problem with the server, or with the communications link to the server, then the access control module does not trust any reservations it might know about and it allows any valid proximity or chip card ID to gain access and use the vehicle. Usage is monitored, and when the link to the server is re-established, the usage information is sent to the server. Reservation information is also sent from the server to the access control module. If the access control module determines that the current driver is using vehicle without a valid reservation, the access control module can sound an alarm altering the driver.

The vehicle-associated access control module can accept new instructions via the wireless communications link to the server. This permits each of these modules to be updated remotely rather than requiring a visit to each of the vehicles every time a modification needs to be made.

The vehicle security system can be overridden for maintenance purposes, either by remote control or by special master IDs of the proximity or chip cards.

Nearly all of the components used in the system are conventional ones and need no detailed description. As stated above, the main feature of the present invention is the convenient and reliable access to shared vehicles.

The system provides for automated monitoring and tracking of vehicle use. If fees are charged for the use of the shared vehicles, bills are generated automatically from tracking data and submitted for automatic payment.

According to the present invention, the management of a fleet of shared vehicles is economical and scalable. Vehicles locations, in the preferred embodiment, are distributed over a wide area. The system minimizes infrastructure costs by completely containing the components of the system that implement the shared access and vehicle monitoring within the vehicle. This allows vehicles to be stored in any parking location rather than limiting storage to specific locations that have been built or modified for them, such as special parking facilities, kiosks, or barriers. It also permits vehicles to be moved to new parking locations and allows a large number of new vehicles to be added without the need to build any additional parking location-specific infrastructure.

Once the system components are installed in a vehicle, they may be reprogrammed via a wireless connection, thus obviating the need to visit each vehicle. This allows for more efficient and more scalable management of system development and improvements.

The present invention thus reduces the total number of cars in a city because it allows a shared vehicle to replace a number of private vehicles. The availability of shared-access vehicles will encourage some drivers to dispose of their cars, some to defer purchase of a car, and others to leave their vehicles at home. Drivers using shared cars will likely drive less than drivers of private vehicles because the costs of each trip are externalized and the drivers tend to make a rational decision each time they need to get somewhere.

The system has a vehicle-associated access control module for enabling access to the vehicle by an authorized driver. The driver must first complete a verification sequence, showing that the driver is authorized. The system, at the zipcar.com server, has a verification module that communicates with the vehicle-associated access control module. The vehicle-associated access control module and the remote verification module communicate over a communications channel. These components and the overall system are described in more detail below, and in conjunction with the Figures.

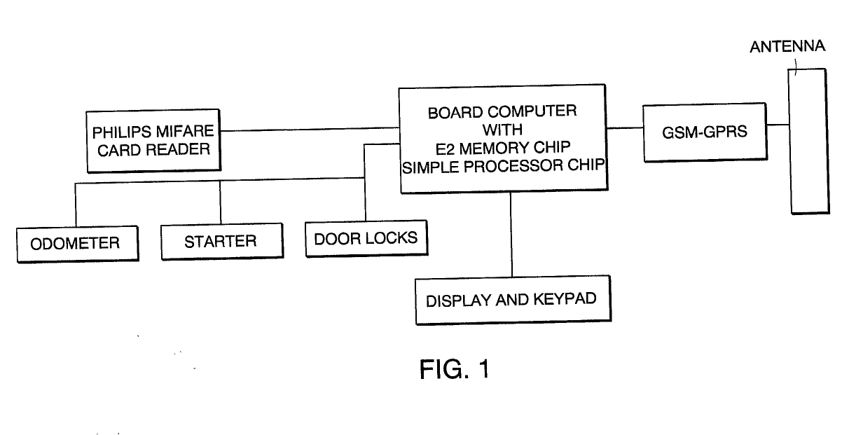

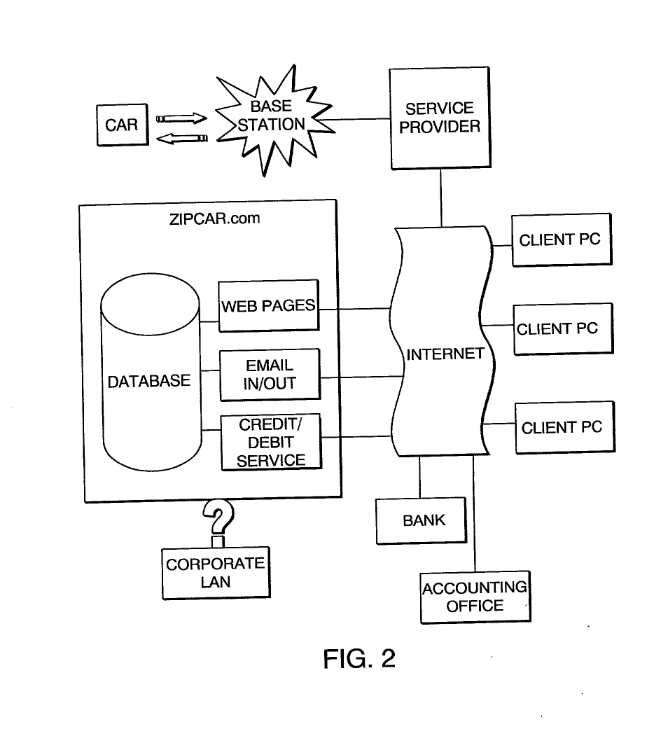

FIG. 1 illustrates one embodiment of the vehicle-associated access control system. The chip card reader 105, a Philips MIFARE Card Reader, detects a chip card and signals the Board Computer 101. The Board Computer 101 first determines whether or not the communication link to the Zipcar.com server (shown in FIG. 2) via GSM-GPRS wireless modem 102 and Antenna 103 is enabled. If the communication link is enabled, the reservation data stored on the board computer are trusted and the board computer compares the ID of the proximity or chip card presented with the ID in each stored reservation. If the ID matches an appropriate reservation, the board computer unlocks the car door via the door locks module 107 and enables the ignition via the starter module 106. The display and keypad 108 can be used for further driver verification by requesting a driver-specific code be entered and compared before enabling the ignition. The display and keypad 108 can further be used to solicit information from the driver regarding the status of the vehicle and reservation. The display and keypad 108 can also be used to enable the driver to change the current reservation. The display and keypad 108 can also be used to create a new reservation if there is not one for this vehicle already. During use, Board Computer 101 monitors the Odometer 104. The total distance that was traveled during the reservation is stored for later transmission to the Zipcar.com server via GSM-GPRS 102 and Antenna 103. The system may also include a Global Position System (GPS) that allows the system to determine the location of each of the cars, both when in use and when not in use.

FIG. 2 illustrates one embodiment of the overall system. The vehicle-associated access control system is contained in a plurality of cars 201 that communicate via wireless link through a base station 202 and a service provider 203 that is a gateway to the Internet 208. Typically, base station 202 and service provider 203 are components in a network provided by a wireless data service provider such as Verizon or Omnipoint or AT&T. The client PCs 209, 210, and 211 are used to access the Zipcar.com server 215 via the Internet 208 so that vehicle availability can be reviewed and reservations created. The accounting office 214 is also connected to the Internet allowing accountants to review the system activity and charges. Drivers can also review their own account status via their own PC (represented by PCs 209, 210, and 211) by accessing the Zipcar.com server 215 though the Internet 208. The Bank 213 is a payment processor that permits the Zipcar.com server 215 to automatically charge for usage of the cars and other fees via the Credit/Debit service module 207 in the Zipcar.com server 215. The Zipcar.com server 215 contains a database 204 that stores all the information necessary to manage the resource management reservation system. Web pages 205 are constructed by the Zipcar.com server 215 using information from the database 204 and can be displayed on the client PCs 208, 209, 210 via the Internet 208. The Zipcar.com server 215 can also send and receive email via the Email In/Out module 6 via the Internet 208. The corporate LAN 212 is connected to the Zipcar.com server 215 via a secure link allowing office personnel to manage the server.

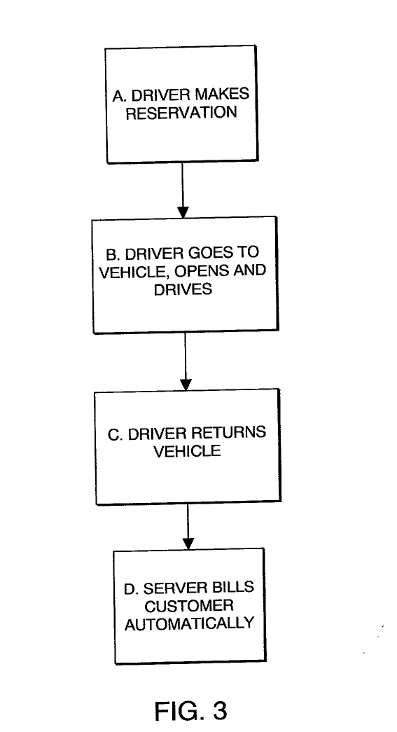

FIG. 3 describes the system from the point of view of the driver who wants to use a vehicle. As shown in Step A, the driver makes a reservation for a specific vehicle or one of a pool of vehicles parked in a specific location for a specific period of time. In Step B the driver goes to the specific location and gains access to the vehicle or one of a pool of vehicles using their proximity or chip card and uses the vehicle. In Step C the driver returns the vehicle to a specific location. In Step D the driver is billed automatically for their use of the vehicle.

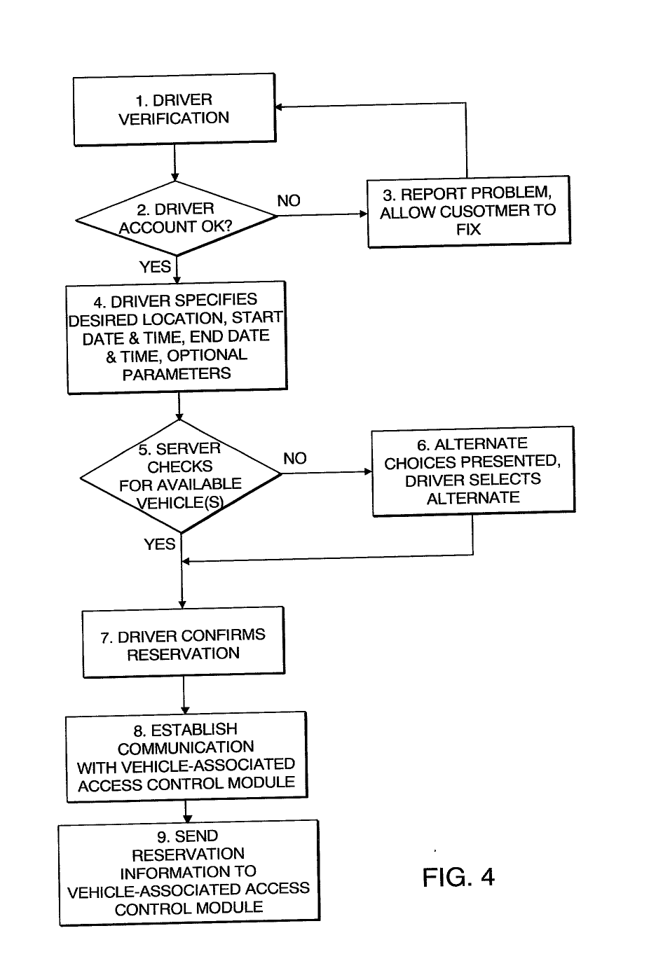

FIG. 4 describes the method to make a reservation (Step A of FIG. 3) in more detail. The driver's identity is verified, as shown in step 401, by any of various means including entering a username and password. Once the driver identity is verified, the zipcar.com server checks the driver account, shown in step 402, to make sure the driver is permitted to charge usage on the account. If the account is not verified, the driver may rectify whatever the problem is, such as enter a new credit card number, as shown in step 403. Once the driver's account is processed and accepted, then the driver specifies the desired location, start date and time, end date and time, and other optional parameters, shown in step 404. Individual driver preferences are stored in a database and preferences include the preferred city, neighborhood, location, vehicle type, and other such information. The system examines the individual driver's preferences to facilitate the selection of the desired reservation parameters, as shown in step 404.

As shown in step 405, the zipcar.com server checks for any available vehicle or vehicles that match the preferences specified. If no vehicles are available that match the preferences, alternative choices are presented to the driver, as shown in step 406. These alternatives are displayed ordered by the most likely preferred choices first, and the least likely preferred choices last. For example, the most likely choices may be the available vehicles nearest to the preferred vehicle. In this case, the locations of all vehicles are known and a well-known formula may be used to calculate the distance from the preferred vehicle to the available vehicles.

After the vehicle availability is confirmed, or an alternative vehicle is chosen, shown in step 406, the driver confirms the reservation, shown in step 407. The confirmation step allows the driver to select from among several available vehicles that match the preferences. The driver is also able to estimate the cost of the reservation by entering anticipated usage.

After the reservation is confirmed, the zipcar.com server establishes communication with the appropriate vehicle-associated access control module. Once this communication is established, the server transfers the reservation information, shown in step 409, to the vehicle-associated access control module.

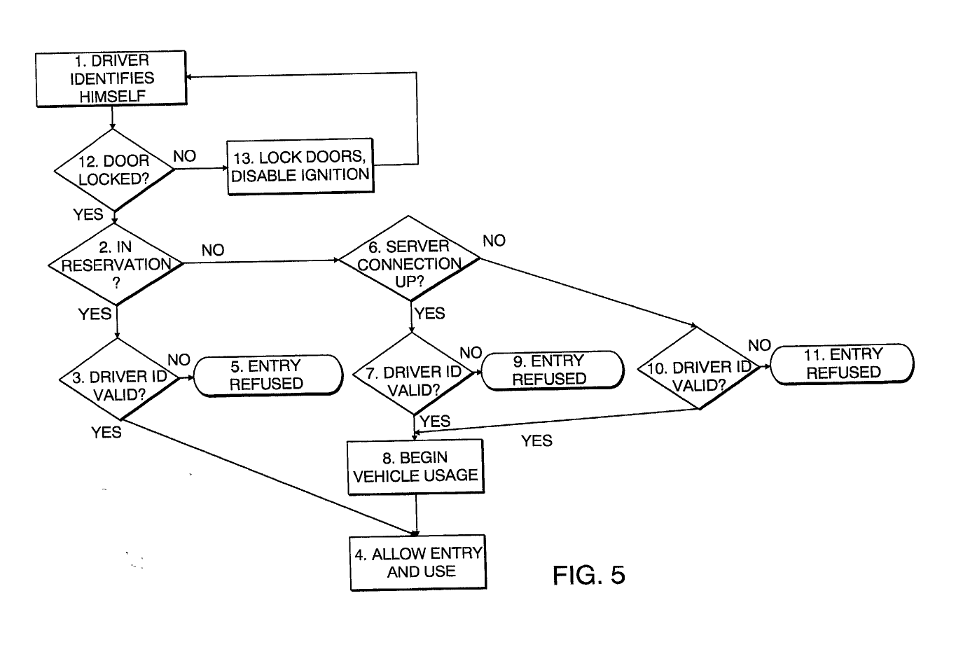

FIG. 5 describes Step B of FIG. 3 in more detail. In FIG. 5, the driver goes to the specific location and gains access to the vehicle. The operations shown in FIG. 5 are implemented by the vehicle-associated access control module. As shown in step 501 of FIG. 5, the driver first identifies himself to the system. In the preferred embodiment, the means of identification is a proximity card, which could be provided by Applied Wireless Identification Group, Inc. (AWID) model Prox-Linc CS or KT. In the preferred embodiment, the access control module is equipped with a detector, which could be AWID model SR2400-ZIP. According to the system, the vehicle-associated processor is in communication with a proximity card detector that enables access to the vehicle only when a validated proximity card is placed in proximity to the card detector. The vehicle-associated processor may include associated audio/visual display elements, such as a visual display or a speaker. In an alternate embodiment, the vehicle-associated processor may also include data entry elements the user accesses to enter authorization data, such as a keyboard or a touch-screen, or other devices available to enter a user-associated personal identification number for validation.

As shown in step 512 of FIG. 5, the access control module determines whether the doors are locked or not. If the doors are not locked, as shown in step 513, the vehicle-associated access control module sends a signal that causes the doors to be locked and the ignition to be disabled. The access control module then returns to wait for another signal from the proximity card detector. If the doors are locked, as shown in step 502, the processor determines if a reservation has begun.

If a new reservation has begun, as shown in Step 503, the ID from the proximity card is compared with the card ID for the current reservation. If the card ID matches, as shown in step 504, the processor sends a signal to the door unlock mechanism and enables the ignition via the Ignition Disable. If the ID does not match, as shown in step 505, access is refused by keeping the doors locked and the ignition remains disabled. If, as shown in step 502, the processor determines that a reservation has not begun, the status of the wireless connection via the wireless modem and antenna to the zipcar.com server is queried (step 506). If the connection is enabled, the reservation data stored in Board Computer 101 is trusted and the card ID from the proximity card is compared with the stored reservations (step 507). If the card ID matches, the processor records the beginning of the vehicle usage for this reservation (step 508). The system then allows for vehicle usage, shown in step 504. If the card ID does not match, access is refused.

If the system determines that the wireless connection is down, a simpler test of the card ID is performed. If the card ID is determined to be valid, the start of vehicle usage is logged as above. If the card ID is determined to be invalid, access is refused. The system may perform a further check to determine if the card ID matches a list of master ID numbers permitted to access the vehicle at all times (shown at steps 503, 507, and 510). As shown in step 507, a driver may be permitted access to the vehicle without a reservation. If the vehicle-associated access control module is equipped with a keyboard, user interface processor, and display, the driver may create a new reservation by entering desired information via the on-board keyboard. In certain embodiments, a driver is permitted access to the vehicle without a pre-authorized ID. In such a case, the resource management reservation system performs an authorization before allowing vehicle use. Such an authorization could include a background driving record check for insurance purposes and a credit check to determine creditworthiness.

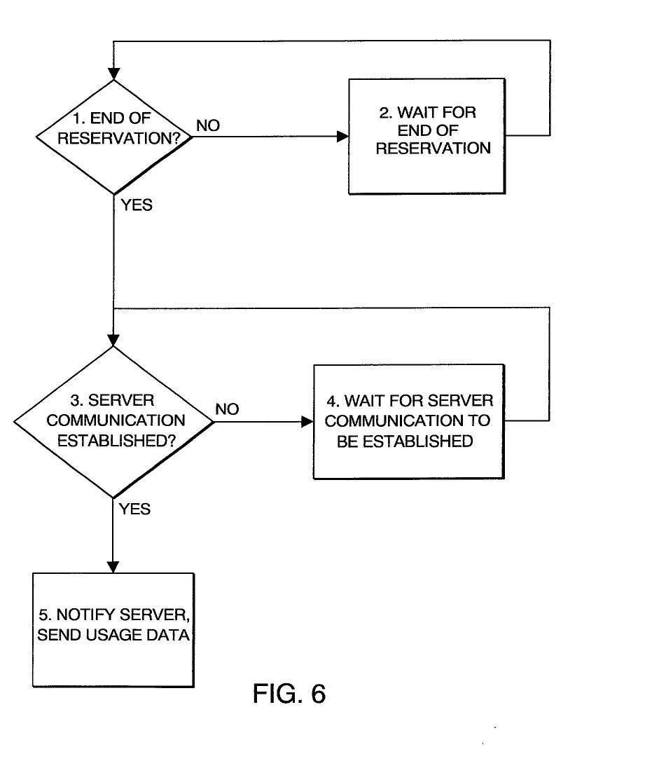

FIG. 6 describes Step C of FIG. 3 in more detail. Each time the processor determines via the on-board vehicle system that the vehicle has been turned off, it determines whether the reservation has ended. If the reservation has not ended, the system will continue to wait until the end of the reservation. If the processor determines that the reservation has ended, the status of the wireless connection is determined, as shown in step 603. If the wireless connection is not enabled, the system will wait until the connection is established (shown in step 602). If the connection is enabled, the processor sends the vehicle usage details, such as the start of usage, the end of usage, the card ID of the user, and the vehicle status to the zipcar.com server.

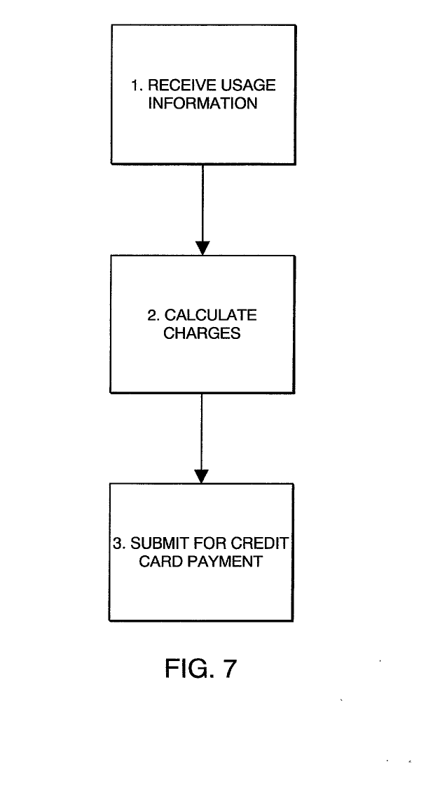

FIG. 7 describes Step D of FIG. 3 in more detail. As shown in step 701, the zipcar.com server receives usage information from the vehicle-associated access control module. As shown in step 702, charges for a particular use of the vehicle may be calculated based on a number of factors including which vehicle was used, from which parking location, for how long and at what time of day, the distance driven, which driver, and other system-set parameters. As shown in step 703, the charges are automatically submitted for payment.

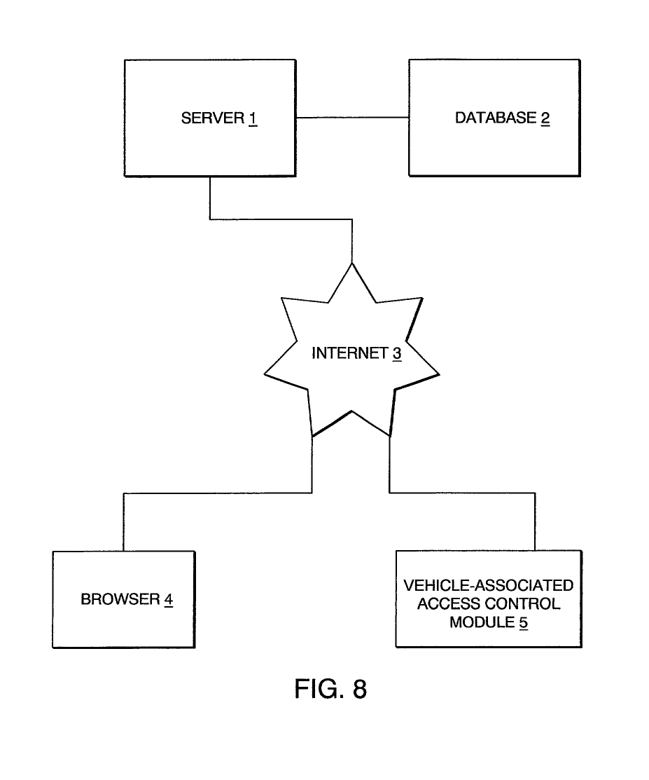

FIG. 8 shows the components of the overall system. The zipcar.com server 801 is connected to a database 802 that stores all the necessary information to manage the resource management reservation system. The zipcar.com server 801 is connected to the Internet 803 that allows a plurality of browsers 805, also connected to the Internet 803, to be used by the system of the present invention to reserve vehicles, view vehicle availability, review account status, report problems with vehicles, and perform other functions. A plurality of vehicle-associated access control modules 805 are also connected to the Internet 803 via a wireless link enabling communication between the onboard vehicle-associated access control modules 805 and the zipcar.com server 801.

When an authorized user, or driver, requests a reservation for a car, the system accesses the database 802 and registers in the database 802, a reservation information item that represents the identity of the authorized user, the identity of the requested vehicle or vehicles, and the time requested by the reservation. When the system subsequently accepts, from a vehicle-associated processor 805, a request-to-access message indicating that the user is at a vehicle and is requesting access to the vehicle, the system responds by verifying the access request. The system, to perform verification, first determines the identity of the user requesting access to the vehicle. The system then compares the identity of the user requesting access to the vehicle, the identity of the vehicle, and the time of the request for access, against information contained in the reservation information item in the database. If the user requesting access is the user registered in the database and the vehicle is one of the vehicles registered in the database, and the time of the request is also registered in the database, the system enables the user to access the vehicle.

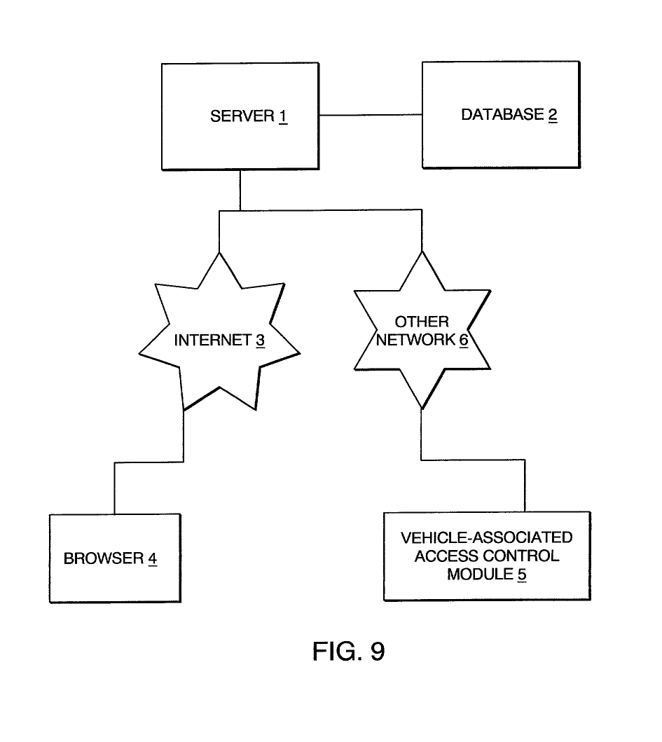

FIG. 9 is an alternate embodiment of the system for shared use of a vehicle according to the present invention. In some cases, the wireless link to the vehicle-associated access control modules 905 may not be via the Internet 903, but the connection may also be through some other network 906. This may be the case with the GSM network. The overall system and the other components are similar to that shown in FIG. 8.

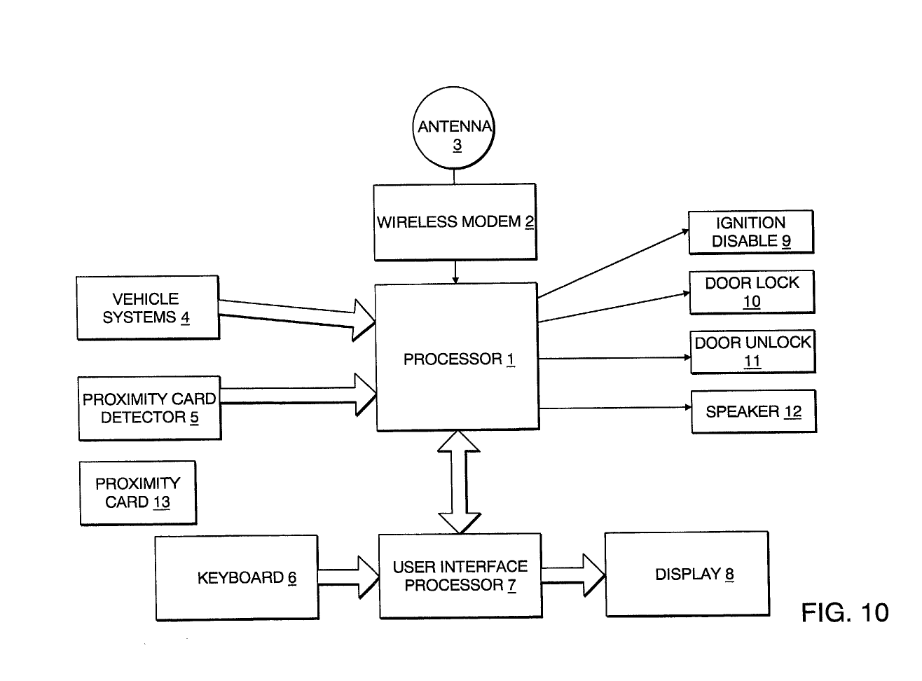

FIG. 10 shows the vehicle-associated access control modules system in more detail. As shown in FIG. 10, the processor 1001 monitors vehicle systems 1004, and determines various vehicle-specific facts, including whether the engine is running or not, the odometer reading, the battery voltage level, and other vehicle-specific facts. The processor 1001 also monitors an on-board GPS system and maintains the current location of the vehicle. The processor 1001 also monitors the proximity or chip card detector 1005. The processor 1001 is able to communicate with the zipcar.com Server via the wireless modem 1002, which in this example is a CDPD modem, Novatel Wireless Expedite model and antenna 1003. The proximity or chip card 1013 is used to identify the driver and is detected by the proximity chip card detector 1005. Processor 1001 is able to enable and disable the vehicle ignition via ignition disable 1009. Processor 1001 is able to lock the doors via door lock 1010. Processor 1001 is able to unlock the doors via door unlock 1011. Processor 1001 is able to sound an alarm via speaker 1012. A user interface processor 1007 may be optionally connected to processor 1001. This permits driver to enter data via keyboard 1006 or other input device. This also permits the display of information to the driver via display 1008.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A system for controlling access to a vehicle, the system comprising:
a vehicle-associated access control module for enabling access to the vehicle by a first authorized user following completion of a verification sequence,
a verification module for enabling completion of the verification sequence through communications with the vehicle-associated access control module, and
a communications channel for supporting communications between the vehicle-associated access control module and the remote verification module.

2. The system of claim 1 wherein the communications channel includes the Internet.

3. The system of claim 2 wherein the communications channel includes wireless communications elements.

4. The system of claim 3 wherein the verification module includes a server that stores personal identification information representative of the first authorized user.

5. The system of claim 4 wherein the server includes elements for enabling the first user to reserve, in advance, a predetermined period of access to the vehicle.

6. The system of claim 5 wherein the server includes elements for verifying, in real-time, a personal identifier provided by the first authorized user as a prerequisite to completion of the verification sequence.

7. The system of claim 6 wherein the personal identifier includes a personal identification number.

8. The system of claim 6 wherein the personal identifier includes a personal identification object.

9. The system of claim 8 wherein the personal identification object is an electronic device containing a unique code representative of the first authorized user.

10. The system of claim 9 wherein
the electronic device is a chip card or tag, and
the vehicle-associated processor is in communication with a chip card detector that enables access to the vehicle only when a validated chip card is placed in proximity to the card detector.

11. The system of claim 10 wherein the vehicle-associated processor includes associated audio/visual display elements.

12. The system of claim II wherein the audio/visual display elements include a visual display and a speaker.

13. The system of claim 12 wherein the vehicle-associated processor includes data entry elements for use by the user to enter data.

14. The system of claim 13 wherein the data entry elements include a keyboard.

15. The system of claim 13 wherein the data entry elements include a touch-screen.

16. The system of claim 13 wherein the data entry elements can be used to enter a user-associated personal identification number to identify the user.

17. The system of claim 16 wherein the vehicle-associated processor includes a user interface processor for processing information-representative signals from the data entry elements and to the display.

18. The system of claim 17 wherein the vehicle-associated processor is in communication with an ignition disabling module for preventing actuation of vehicle ignition unless the verification sequence is successfully completed.

19. The system of claim 18 wherein the vehicle-associated processor is in communication with door lock actuator elements, for unlocking the vehicle door locks after the verification sequence is successfully completed.

20. The system of claim 19 wherein the vehicle-associated processor includes a wireless modem.

21. The system of claim 20 wherein the wireless modem operates in accordance with a known wireless technology.

22. The system of claim 21 wherein the wireless technology is CDPD

23. The system of claim 21 wherein the wireless technology is GSM.

24. The system of claim 21 wherein the server is capable of communication with each of a plurality of vehicles in a fleet of vehicles.

25. The system of claim 24 wherein
reservations can be accepted from a plurality of authorized users for a single vehicle or each of a plurality of vehicles in a fleet of vehicles, and
the reservations include selected pickup and drop-off times and locations.

26. The system of claim 25 wherein the system prevents other authorized users other than the first authorized user from obtaining access to the first vehicle during a reservation time.

27. The system of claim 26 wherein the system accepts and registers newly added vehicles and vehicle-associated access control modules.

28. The system of claim 27 wherein the vehicle-associated access control module can monitor total access time and distance covered.

29. The system of claim 28 wherein total access time is measured from vehicle pickup time to drop-off time.

30. The system of claim 29 wherein distance covered is measured from vehicle pickup to drop-off.

31. The system of claim 27 wherein the communications channel includes a program for communication between the vehicle-associated access control processor and the server and a database resident on the server.

32. The system of claim 31 wherein the vehicle-associated access control processor is capable of communicating with the server via 1) the Internet, or (2) another communications network.

33. The system of claim 5 wherein the vehicle-associated access control processor includes elements for verifying, in real-time, a personal identifier provided by the first authorized user as a prerequisite to completion of the verification sequence

34. A method of providing controlled access to a vehicle, the method comprising
accepting from a first authorized user a reservation of access to a first vehicle at a first time,
registering, in a database, a reservation information item representative of the identity of the first authorized user, identity of the first vehicle or pool of vehicles, and a value representative of the first time prescribed by the reservation,
subsequently accepting, from a vehicle-associated processor, a request-to-access message indicating that a user is at the first vehicle or one of a pool of vehicles requesting access thereto,
responding to the request-to-access message by entering into a verification sequence, the verification sequence including (1) determining the identity of the user requesting access to the vehicle and (2) comparing, against information contained in the reservation information item in the database, the identity of the user requesting access to the vehicle, the identity of the vehicle, and the time of the request for access, and
if (1) the user requesting access is the first user, (2) the vehicle is the first vehicle or one of a pool of vehicles, and (3) the time of the request for access is the first time, then enabling the first user to access the vehicle.

35. A method of enabling controlled vehicle access by a first authorized user to a first vehicle within a fleet of vehicles, the method including the steps of
accepting an advance reservation by the first authorized user to reserve access to the first vehicle at a first authorized location beginning at a first authorized time,
verifying, when the first authorized user reaches the first vehicle at the first authorized time, that the first authorized user has a valid reservation for access to the first vehicle at the first authorized time, and
enabling the first authorized user, following successful completion of the verifying step, to gain access to and initiate operation of the first vehicle.

36. The method of claim 35 comprising the further steps of:
recognizing, when the first authorized user returns the first vehicle to either the first authorized location or a second authorized location, the return of the first vehicle, and
automatically billing an account of the first authorized user upon return of the first vehicle.

37. The method of claim 36 wherein the step of accepting a reservation includes the step of verifying the identity of the user attempting to make a reservation.

38. The method of claim 37 wherein the step of verifying the identity of the user attempting to make a reservation includes the step of verifying the status of the user's account.

39. The method of claim 38 including the further step of notifying the user if a problem exists with the user's account.

40. The method of claim 39 wherein the step of accepting a reservation includes the step of enabling the user to specify requested vehicle, requested pickup location, request vehicle access start date and time, and requested vehicle access end date and time.

41. The method of claim 40 wherein the step of accepting a reservation includes the further step of verifying whether the requested vehicle is available at the requested pickup location at the requested start date and time.

42. The method of claim 41 including the further step of presenting the user with alternate choices if the requested vehicle is not available at the requested pickup location at the requested vehicle access start date and time.

43. The method of claim 42 including the further step of transmitting, upon acceptance of the reservation, information representative of the reservation to a vehicle-associated access control processor.

44. The method of claim 43 wherein the step of verifying that the user has a valid reservation for access to the vehicle includes the further steps of:
enabling the user to provide to the vehicle-associated access control processor information representative of the user's identity,
verifying, using the vehicle-associated access control processor, whether the user, identified by way of the information representative of the user's identity, has a reservation,
if the identified user has a reservation, verifying whether the identification provided by the user to the vehicle-associated access control processor is valid, and
if the customer identification is valid, authorizing the step of enabling the user to obtain access to the vehicle.

45. The method of claim 44 wherein the verifying steps are executed by the vehicle-associated access control processor checks in communication with a database.

46. The method of claim 45 wherein the database is resident on a server.

47. The method of claim 46 wherein
the verifying steps include the further steps of
checking, using the vehicle-associated access control processor, whether a communications channel to the server is available, and
if a communications channel to the server is available, verifying whether the customer identification is valid by comparing with information in the server's database or a local copy of this information resident in the vehicle-associated access control processor; or
if a communications channel to the server is not available, checking whether the customer identification by comparison with information resident in the vehicle-associated access control processor.

48. The method of claim 47 wherein access is refused if the identified user does not have a reservation.

49. The method of claim 47 wherein access is refused if the identified user's identification is not valid.

50. The method of claim 49 wherein the step of recognizing return of the vehicle includes the further steps of:
notifying the server of vehicle return and transmitting, to the server, usage information representative of usage time and distance covered.

51. The method of claim 50 further including the step of automatically billing a user after recognizing the return of the vehicle, wherein the step of automatically billing includes the further steps of:
receiving usage information,
calculating charges corresponding to usage time and distance covered, and
transmitting for payment the calculated charges.

52. A vehicle shared-use system comprising a plurality of vehicle-associated access control processors and a verification module, the system comprising:
means for enabling access to a vehicle by a first authorized user following completion of a verification sequence,
means for enabling completion of the verification sequence through communications with one of the vehicle-associated access control module, and
means for communicating between the vehicle-associated access control module and the remote verification module.
